(19) United States
(12) Patent Application Publication
(10) Pub. No.: US 2008/0249949 A1
(43) Pub. Date: Oct. 9, 2008

(54) Data Exchange method between multiple peer systems in a peer-to-peer network

(76) Inventors: Chia-Chin Wang, Taipei City (TW); Yung-Chieh Lin, Taipei City (TW); Ming-Tsung Lin, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/733,163

(22) Filed: Apr. 9, 2007

(51) Int. Cl. H04L 9/30

(52) U.S. Cl. 705/75

(57) ABSTRACT

A data exchange method between a first peer system having a requested data chunk and a second peer system having a credit includes: exchanging the credit of the second peer system for the requested data chunk of the first peer system; and using the credit received by the first peer system to exchange for a future data chunk from the second peer system at a later time.

### BACKGROUND OF THE INVENTION

1. Field of the Invention

The present invention relates to data exchange, and more particularly, to a data exchange method between multiple peer systems in a peer-to-peer network.

2. Description of the Prior Art

A peer-to-peer (P2P) network is computer network that allows for the decentralization of information and data. Instead of localizing information on one central mainframe or server, as in a traditional network system, P2P networks can share information or data across multiple nodes, or peer systems. Because a single server need not fully carry the entire contents of the requested data, data between nodes can be dynamically exchanged, where any participating node can simultaneously upload and download data between other nodes until the desired data content is fully attained. The P2P network does away with the client-server roles of traditional network relationships 100, as illustrated in FIG. 1. In the traditional role 100, there is a central server 110 that fully contains a file that is downloaded by a plurality of clients 120. The client 120 is thus solely dependent on the server 110 to attain the desired file, and cannot attain the file through other clients 120. P2P systems have become extremely popular as of late due to their usefulness in file sharing capabilities. Content files, such as audio, video, games, and/or any type of digital information is commonly shared between millions of nodes daily.

FIG. 2 illustrates the basic configuration of the P2P network 200. As shown in FIG. 2, a plurality of nodes (or peer systems) 210 act to form the P2P network 200. Every peer system 210 acts as an equal, and simultaneously functions as a server and a client. Every peer system 210 can thus download chunks of large data files from another peer system having the data, while also uploading requested data to another peer system 210. Peer systems must therefore cooperate in order to effectively share or transmit data across other peer systems 210 in the network.

A main advantage of P2P networks is the increased transmission speeds and bandwidth it offers over traditional data exchange networks. By avoiding the downloading of data from a single or isolated number of servers, traffic and congestion is significantly reduced. In the traditional client-server network model, the addition of clients would tend to slow down transmission speeds because they would all attempt to access the server simultaneously. In a P2P system however, because peer systems act as both servers and clients, additional peer systems increase the total capacity of the system and do not result in the same type of download congestion. Once nodes in a P2P system receive chunks of data files, they can begin to distribute it to other nodes who are in need of the same chunk. The P2P network therefore relies primarily on the computing power and bandwidth of other peer systems in the network, as opposed to that of a central server.

As described earlier, the overall effectiveness of the P2P system is dependant upon the effective cooperation of the each peer system in the peer system-to-peer network. In order to prevent malicious peers who may abuse the network by only downloading chunks without contributing data, a theoretical protocol called “tit-for-tat” is often utilized. Tit-for-tat is a mutually based arrangement, where a first peer system would only offer a data chunk to a second peer system, if the second peer system could offer a desired data chunk back to the first peer system in return. However, if the second peer system violates this arrangement and does not offer the first peer system a desired data chunk, the first peer system would then cease to continue offering data chunks to the second peer system.

A problem arises, however, when a peer system has completely downloaded all chunks of a large data file and becomes a seeder (primary uploader). In this case, the peer system does not have any interest in receiving data chunks from other peer systems, as it has already attained the entire file. Therefore, the peer system may decide to leave the network at any time as it has no further incentive to stay. In another situation, if a first peer system desires a data chunk from a second peer system, but the first peer system does not have any data chunks that the second peer system wants, an exchange may not occur under the tit-for-tat protocol, as there is no mutual benefit for both peer systems in such a case. Both cases highlight inherent problems in the P2P architecture that act to reduce the overall effectiveness of data transmission between peer systems.

### SUMMARY OF THE INVENTION

One objective of the claimed invention is therefore to provide a data exchange method between multiple nodes in a peer system-to-peer network to solve the above-mentioned problem.

According to an exemplary embodiment of the claimed invention, a data exchange method between a first peer system having a requested data chunk and a second peer system having a credit is presented. The method comprises: exchanging the credit of the second peer system for the requested data chunk of the first peer system; and using the credit received by the first peer system to exchange for a future data chunk from the second peer system at a later time.

According to another exemplary embodiment of the claimed invention, a data exchange method between a plurality of peer systems including at least a first peer system having a first data chunk, a second peer system having a second data chunk, and a third peer system having a credit is presented. The method comprises: exchanging the credit of the third peer system for the first data chunk of the first peer system; and using the credit received from the third peer system by the first peer system to exchange for the second data chunk of the second peer system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the traditional client/server network configuration according to the prior art.

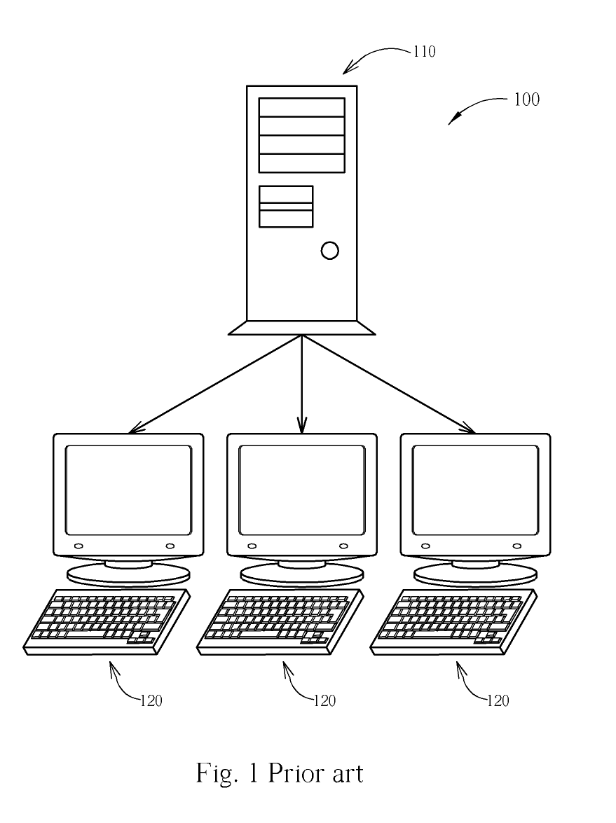

FIG. 2 is a diagram illustrating the peer system-to-peer network configuration according to the prior art.

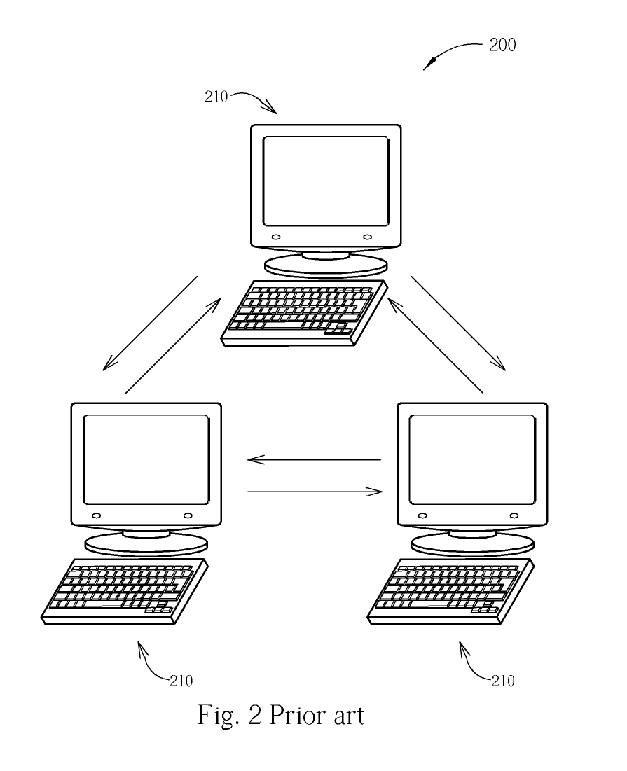

FIG. 3 is a first embodiment of the data exchange method according to the present invention.

FIG. 4 is a graphical illustration outlining the exchange of credits and data chunks between peer systems in the peer-to-peer network.

FIG. 5 is a diagram illustrating the encryption/decryption process for credits according to an embodiment of the present invention.

FIG. 6 is another embodiment of the data exchange method according to the present invention.

FIG. 7 is a graphical illustration outlining the exchange of credits and data chunks between multiple peers in a peer-to-peer network having at least three peers.

### DETAILED DESCRIPTION

According to the prior art peer-to-peer (P2P) implementations, there are situations where the effective sharing of data chunks forming large files is under-optimized. This could be caused from a seeder with a completed download file leaving the network, as it does not need any more chunks of the file nor does it have any incentive to remain connected to the P2P network. Alternatively, under the “tit-for-tat” protocol, a seeder with a partially completed download of the data file may not share data chunks with another peer system because it may not require any data chunks which that peer system may have. Both scenarios therefore act to limit the effective sharing of data files across the P2P network.

In order to solve the problems described above, and enhance the availability and effectiveness of peer system-to-peer file transfers, the method of the present invention introduces a credit system to provide an incentive for seeders to stay connected to the P2P network. The method also provides incentive for peer systems with partially completed downloads to share data chunks when they otherwise do not have reason to do so.

When a requesting peer system needs a data chunk from a serving peer system, but the serving peer system isn't interested in any of the data chunks the requesting peer system has, the requesting peer system can instead exchange a credit for the needed data chunk. The serving peer system can then redeem the credit at a later time for a desired chunk from the requesting peer system.

Alternatively, if the requesting peer system holds a credit received from the serving peer system, the requesting peer system can redeem the credit for the desired data chunk from the serving peer system, even though it does not have any data chunks of interest to the serving peer system.

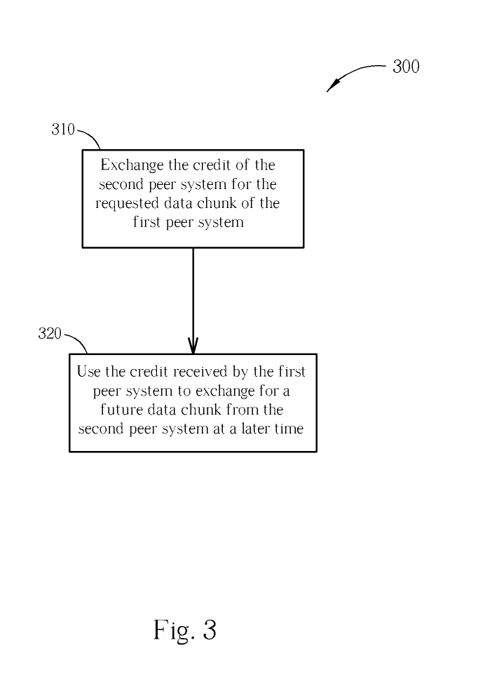

A first embodiment of the data exchange method 300 is illustrated by way of the process flow chart in FIG. 3. Please note that although this embodiment only discusses the utilization of two peer systems, additional embodiments may have a further number of peer systems. Provided that substantially the same result is achieved, the steps of the process 300 need not be in the exact order shown and need not be contiguous, that is, other steps can be intermediate. The data exchange method between a first peer system having a requested data chunk and a second peer system having a credit comprises:

Step 310: Exchange the credit of the second peer system for the requested data chunk of the first peer system; and

Step 320: Use the credit received by the first peer system to exchange for a future data chunk from the second peer system at a later time.

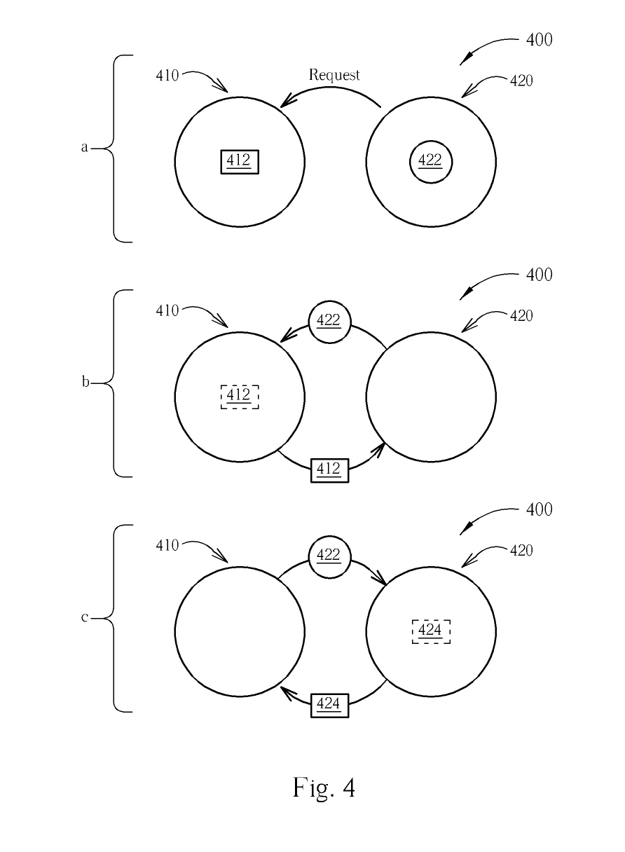

FIG. 4 additionally describes this method through a visual example. An exemplary peer system-to-peer network 400 is shown having a first peer system 410 and a second peer system 420. The first peer system 410 and the second peer system 420 interact amongst each other in order to attain data chunks to complete the download of a mutually desired data file. Suppose the first peer system 410 possesses a requested data chunk 412 that the second peer system 420 wants. In this situation, the second peer system 420 would request the requested data chunk 412 from the first peer system 410 (FIG. 4(a)). The first peer system 410 would in turn look for a needed data chunk from the second peer system 420. However, if the second peer system 420 does not have any data chunks needed by the first peer system 410, it can alternatively offer a credit 422 in exchange for the requested data chunk 412. The second peer system 420 therefore offers the credit 422 in exchange for the requested data chunk 412 of the first peer system 410 (FIG. 4(b)). At a latter time, the second peer system 420 may possess a future data chunk 424 that the first peer system 410 wants. The first peer system 410 can now exchange for the future data chunk 424 of the second peer system 420 by redeeming the credit 422 previously attained from the second peer system 420 (FIG. 4(c)). When the second peer system 420 finally receives its originally issued credit 422 back, it has completed its obligation to the first peer system 410, and can cancel or de-authorize the credit 422 such that it is no longer in use. Canceling the credit 422 may help prevent the credit 422 from being involved in future fraudulent activities.

In additional embodiments the credit may include an expiry limit to indicate the time limit in which the first peer system must redeem the credit. The first peer system would then act to use the credit in exchange for the future data chunk of the second peer system prior to the expiry limit. Otherwise the credit would be invalidated if it were redeemed after expiry.

To keep record of the exchanges and transactions between the multiple peer systems, the credits used can also include a transaction record. The transaction record can indicate relevant information, such as: the original issuer of the credit, the intended recipient of the credit, the sender of the credit, the time of the transaction, the expiry limit of the credit, the data chunk exchanged for the credit, and a checksum of the data chuck to verify successful transmission. Using this information, the first peer system can verify the transaction record prior to exchanging the requested data chunk. Should the transaction record be incorrect or incomplete, the first peer system can then deny exchange of the requested data chunk for the credit. Additionally, if the credit is reused in a following transaction, its transaction record can indicate a history of all prior transactions, which may be helpful in determining the origin and usage of the credit. A subsequent recipient of the credit can identify the original issuer of the credit, previous senders of the credit, and previous recipients if needed in a verification or investigation of the credit.

Another issue when applying the credit-based approach of the present invention is the history of all peer systems with capability of issuing or sending credits. Conceivably, a malicious peer system could indiscriminately and continuously send credits and exchange them with alternate peer systems to attain desired data chunks, with no intention of allowing those peer systems to redeem their credits. This is analogous to the real world example of an individual writing phony checks, or bouncing checks. To prevent this type of behavior, a credit database can be established which maintains a history of all credit issuers and/or senders. Issued credits can be registered with the credit database by the original issuer in order to validate the credit prior to use. Violators of the P2P exchange method (who may consider not registering credits, or duplicating registered credits) can also be reported to the credit database to serve as a warning to potential future partners of the violating peer system. In the example above, the second peer system first registers the credit through the credit database prior to exchange. The first peer system could then verify the transaction record through the credit database prior to exchanging the requested data chunk to ensure its validity. In this way, the first peer is assured of the credit history of the second peer, and can proceed with a greater confidence that the credit received is legitimate and will be honored.

Another common fraud in credit systems based on digital signatures (or encryption/decryption) during redeeming a credit is a problem known as “double spending”, where the same credit is claimed twice. This can uniquely avoided by identifying the credit so each redemption attempt can be checked against the credit database that records all previous redemptions or transactions involving the credit. The transaction record attached to each credit can therefore be utilized for this identification purpose.

Another important area of consideration in the data exchange method of the present invention is the encryption and decryption of credits. This process is also known as “digital signatures”, and is used to digitally sign and verify signatures to ensure the authenticity of the credits involved in a transaction. In order to prevent electronic forgery of credits, and to ensure that only the intended recipients of credits can access and use the received credit from intended senders, the transaction records or credits themselves should be encrypted during the exchange process. As known to those familiar in the related art, peer systems in a P2P network each possess certain encryption keys used to encrypt and decrypt data when communicating between peers. These encryption keys can therefore be applied to the credits (and data chunks if desired) to prevent forgery and/or alteration of the credits.

Each individual peer system possesses a private encryption key, and a public encryption key designated for that peer system. Public encryption keys for many peer systems are also usually made public (hence the term) and are accessible by other peers through a public encryption key database. Alternatively, private encryption keys are not made public, and are only known by the individual peer system which it is intended for. Credits encrypted with a public encryption key of a peer system can only be decrypted with a private encryption key of that same peer system. Also, credits encrypted with a private encryption key of a peer system can only be decrypted with a public encryption key of that same peer system. The public and private encryption keys therefore have an interdependent relationship, where if something is encrypted with one of the keys, it can only be decrypted by the other key.

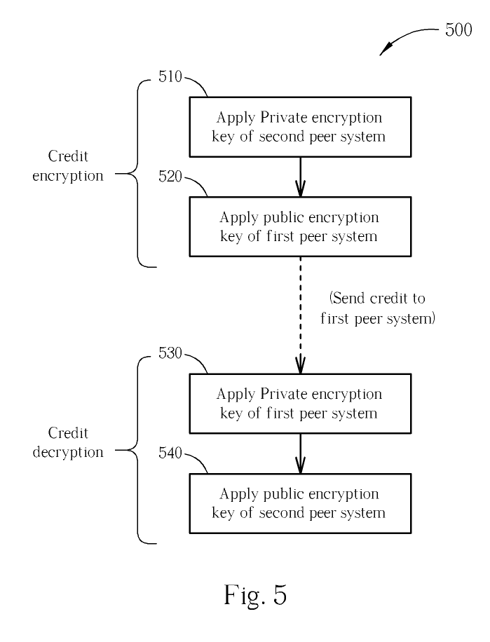

An illustration of how this encryption process 500 can be applied to the data exchange method of the present invention is shown by way of example through FIG. 5. When a second peer system wishes to exchange a credit for a requested data chunk owned by first peer system, the second peer system undergoes credit encryption. The second peer system would begin with encrypting the transaction record of the credit by using a private encryption key of the second peer system (Step 510), followed by applying a public encryption key of the first peer system (Step 520). The credit is now encrypted and can be transmitted to the first peer system, where credit decryption can be performed. To access the credit, the first peer system then decrypts the encrypted transaction record of the credit by using a private encryption key of the first peer system (Step 530), and finally applies a public encryption key of the second peer system to complete decryption (Step 540).

By applying the encryption process 500 of the present invention, only an intended recipient of a credit can access a credit from a specific sender. Also, the intended recipient must know who the sender is to open it, as it must determine the proper public encryption key of the sender. These security mechanisms therefore helps to prevent electronic forgery and manipulation, and serves to limit security issues during the exchange of credits and data chunks.

Further adding to the discussion of the data exchange method 300 shown in FIG. 3, when the first peer system wishes to redeem the credit received from the second peer system for exchange of the requested data chunk (Step 320), the second peer system can also verify the credit to ensure that it was previously issued by or sent from the second peer system (depending on the role of the second peer system in issuing/sending the credit). In this way, the second peer system can prevent possible fraudulent activity by the first peer system, and verify its original obligation is met through accepting this credit. The transaction record of the credit can be verified, and serve as an original record of the initial exchange (Step 310). Also, the credit of the second peer system need not be originally issued by the second peer system. The credit could be issued by a third peer system (not shown) and obtained later by the second peer system for exchange. In this case, when the second peer system receives the credit back from the first peer system, it could verify the credit to make sure it was issued by the third peer system.

Similar to the description above regarding the reception of a credit, when the first peer system wishes to redeem a credit, it should also be encrypted when sent to the second peer system to exchange for a future data chunk. In this case, the first peer system would encrypt the credit with the private encryption key of the first peer system, and then apply the public encryption key of the second peer system as the designated recipient of the credit. When the second peer system receives the credit, it would then decrypt the encrypted credit applying the private encryption key of the second peer system, followed the public encryption key of the first peer system.

While the above description mainly focused on a two peer network system, additional peers may be included in other embodiments. In other practical implementations, a plurality of peers may be realized. However, this may add complications to the credit sharing process, should the same credit be exchanged with multiple peers prior to finally redeeming it with the original credit issuer. In this situation, the same principles of the present invention are still equally applicable, and can be adapted to meet the criteria of exchange between a plurality of peer systems.

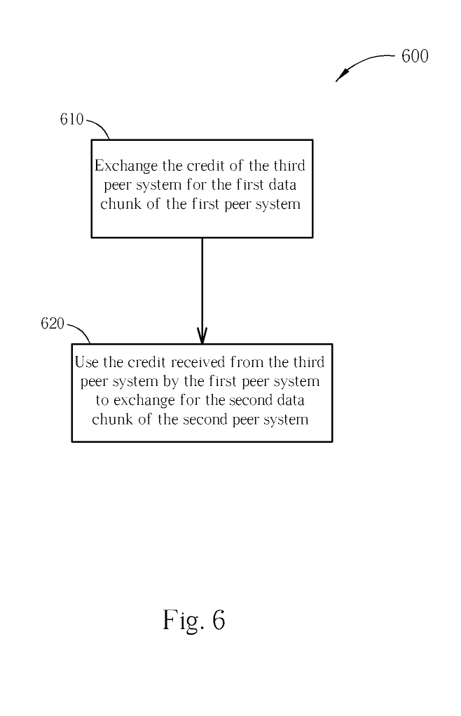

In an alternative embodiment of the present, a data exchange method between a plurality of peer systems 600 is described in the process flow chart of FIG. 6. Provided that substantially the same result is achieved, the steps of the process 600 need not be in the exact order shown and need not be contiguous, that is, other steps can be intermediate. The data exchange method 600 includes at least a first peer system having a first data chunk, a second peer system having a second data chunk, and a third peer system having a credit, the method comprising:

Step 610: Exchange the credit of the third peer system for the first data chunk of the first peer system.

Step 620: Use the credit received from the third peer system by the first peer system to exchange for the second data chunk of the second peer system.

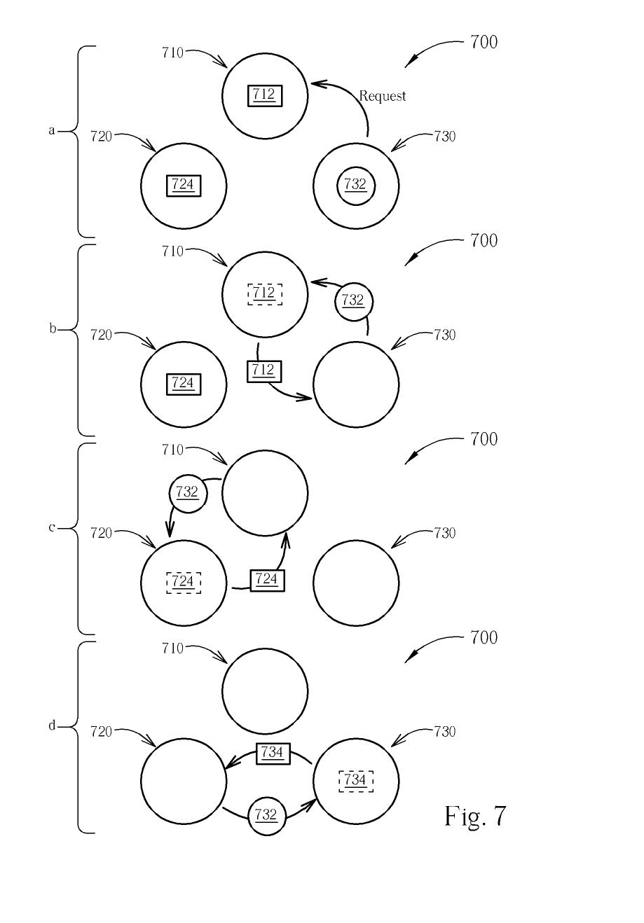

FIG. 7 additionally describes this method 600 through a visual example. An exemplary peer system-to-peer network 700 is shown having at least a first peer system 710 and a second peer system 720 and a third peer system. Although additional peer systems can be implemented, only 3 peer systems are illustrated here for exemplary purposes. Suppose the first peer system 710 possesses a first data chunk 712 that the third peer system 730 wants. In this situation, the third peer system 730 would request the requested data chunk 712 from the first peer system 710 (FIG. 7(a)). The first peer system 710 would in turn look for a needed data chunk from the third peer system 730. However, if the third peer system 730 does not have any data chunks needed by the first peer system 710, it can alternatively offer a credit 732 in exchange for the requested data chunk 712. The third peer system 730 therefore offers the credit 732 in exchange for the requested data chunk 712 of the first peer system 710 (FIG. 7(b)). At a latter time however, the second peer system 720 may possess a second data chunk 724 that the first peer system 710 wants. The first peer system 710 can, instead of redeeming the credit 732 from the third peer system 730, now exchange the credit 732 for the second data chunk 724 of the second peer system 720 by offering credit 732 previously attained from the third peer system 730 (FIG. 7(c)). The obligation made through the credit 732 by the first peer system 710 and the third peer system 730, is now passed onto the second peer system 720. The second peer system 720 may therefore use the credit 732 to exchange for a future data chunk 734 from the third peer system 730. This obligation can be fulfilled at a latter time if the second peer system 720 wants the future data chunk 734 from the third peer system 730. In this case the second peer system 720 would exchange the credit 732 for the future data chunk 734 of the third peer system 730 to fully redeem the credit 732 (FIG. 7(d)).

Similar to the two embodiment example above, in additional embodiments of this method the credit may include an expiry limit to indicate the time limit in which the second peer system must redeem the credit. The second peer system would then act to use the credit in exchange for a data chunk prior to the expiry limit. Otherwise the credit would be invalidated if it were redeemed after expiry.

When the third peer system above receives the credit from the second peer system, in exchange for the future data chunk, it is important that the third peer system verify that the credit was either previously issued or sent by the third peer system. If the third peer system did originally issue the credit, this can be easily verified by comparing the transaction record of the credit it its own records. Alternatively, the credit may be issued by fourth peer system (not shown), from which the third peer system received the credit from. Verification of the credit would prevent fraudulent activity by the second peer system using the credit. As with the previous example, the credit may be encrypted by the second peer system by using a private encryption key of the second peer system and a public encryption key of the third peer system. Decrypting the encrypted credit follows with previous examples, with the third peer system by using a public encryption key of the second peer system and a private encryption key of the third peer system to access the credit for verification.

To keep track of the exchanges and transactions between the multiple peer systems, the credits in this embodiment can also include a transaction record as previously described. The transaction record can indicate relevant information, such as: the issuer of the credit, the intended recipient of the credit, the sender of the credit, the time of the transaction, the expiry limit of the credit, the data chunk exchanged for the credit, and a checksum of the data chunks to verify successful transmission. Using this information, the first peer system can verify the transaction record prior to exchanging the first data chunk with the third peer system. Should the transaction record be incorrect or incomplete, the first peer system can then deny exchange of the first data chunk for the credit.

To prevent fraudulent activity and issues such as “double-spending”, the first peer system can also verify the transaction record through a credit database during the initial exchange. The credit database can be established to maintain a history of all credit issuers and/or senders. Violators of the P2P exchange method can be reported to the credit database to serve as a warning to potential future partners of the violating peer system. The first peer system could verify the transaction record through the credit database prior to exchanging the first data chunk. In this way, the first peer is assured of the credit history of the third peer, and can have greater confidence in the legitimacy of the received credit.

Similar to above implementations, encryption of credits should be used to prevent electronic forgery and abuse of credits, and to ensure that only the intended recipients of credits can access and use the received credit from intended senders.

When a third peer system wishes to exchange a credit for a first data chunk owned by first peer system, the second peer system undergoes credit encryption. The third peer system encrypts the credit by using a private encryption key of the third peer system, followed by applying a public encryption key of the first peer system. The credit is now encrypted and can be transmitted to the first peer system, where credit decryption can be performed. To access the credit, the first peer system then decrypts the encrypted transaction record of the credit by using a private encryption key of the first peer system, and finally applies a public encryption key of the third peer system to complete decryption.

Further adding to the discussion of the data exchange method 600 shown in FIG. 6, if the first peer system wishes to exchange credit received from the third peer system for the second data chunk of the second peer system (Step 620), the second peer system would need to verify the credit and the transaction record to ensure that it was previously issued or sent from the third peer system. The second peer system may directly verify the transaction record with the third peer system that the credit was sent from, to ensure that the obligation of the credit can be forwarded to the second peer system if accepted. If the credit was issued by another peer system (fourth peer system for example), the second peer system could verify the credit with the original issuer of the credit. The second peer system can also verify the transaction record through a credit database to gain confidence in the transaction based on the credit history of the first peer system, and/or the third peer system. Although cumbersome, the multiple verifications used act as a safeguard to prevent fraudulent activity between various members in the P2P network.

When the first peer network exchanges the credit with the second peer network in exchange for the second data chunk, the first peer network would additionally encrypt the credit as in the manner previously described. The first peer network would encrypt the credit using a private encryption key of the first peer system and a public encryption key of the second peer system. When the second peer system receives the credit, it can decrypt it by using a private encryption key of the second peer system and a public encryption key of the first peer system.

When the second peer system wishes to redeem the credit, it would again encrypt the credit when sending it to the third peer system to exchange for the future data chunk. In this case, the second peer system would encrypt the credit with the private encryption key of the second peer system, and then apply the public encryption key of the third peer system as the designated recipient of the credit. When the third peer system receives the credit, it would then decrypt the encrypted credit by applying the private encryption key of the third peer system, followed the public encryption key of the second peer system.

By applying the various embodiments of the present invention data exchange method above, effective sharing across a peer-to-peer network can be maximized. The credit system described therefore provides an incentive for seeders, who have completed downloading large files, to stay attached to the network. The seeder may therefore receive credits from other peers for future data chunks, in exchange for data chunks of the seeder. Alternatively, the problem associated with the “tit-for-tat” protocol can be solved, as credits can now be exchanged when a seeder with a partially completed downloaded data file does not share data chunks with another peer system. This would promote sharing between various peers in spite of one peer not having any data chunks another peer may currently want.

The data exchange method of the present invention therefore provides a credit system to induce seeders to stay connected to the P2P network, and for peer systems with partially completed downloads to share data chunks when they otherwise do not have an incentive to do so. The availability of files and data chunks, and overall effectiveness of peer system-to-peer file transfer is greatly enhanced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data exchange method between a first peer system having a requested data chunk and a second peer system having a credit, the method comprising:
exchanging the credit of the second peer system for the requested data chunk of the first peer system; and
using the credit received by the first peer system to exchange for a future data chunk from the second peer system at a later time.

2. The data exchange method of claim 1 wherein the credit includes an expiry limit, and the method further includes using the credit received by the first peer system in exchange for the future data chunk of the second peer system prior to the expiry limit.

3. The data exchange method of claim 1, wherein the credit of the second peer system includes a transaction record, and the method further comprises the first peer system verifying the transaction record prior to exchanging the requested data chunk.

4. The data exchange method of claim 3 further comprising encrypting the transaction record of the credit with the second peer system by using a public encryption key of the first peer system and a private encryption key of the second peer system, and decrypting the encrypted transaction record of the credit with the first peer system by using a private encryption key of the first peer system and a public encryption key of the second peer system.

5. The data exchange method of claim 3, wherein the first peer system verifies the transaction record of the credit through a credit database.

6. The data exchange method of claim 1 further comprising verifying that the credit received by the second peer system from the first peer system in exchange for the future data chunk was previously issued by the second peer system.

7. The data exchange method of claim 1, wherein the step of using the credit received by the first peer system to exchange for a future data chunk further comprises encrypting the credit with the first peer system by using a private encryption key of the first peer system and a public encryption key of the second peer system, and decrypting the encrypted credit with the second peer system by using a public encryption key of the first peer system and a private encryption key of the second peer system.

8. The data exchange method of claim 1 wherein the credit is issued by the second peer system.

9. The data exchange method of claim 1 wherein the credit of the second peer system is received from a third peer system.

10. A data exchange method between a plurality of peer systems including at least a first peer system having a first data chunk, a second peer system having a second data chunk, and a third peer system having a credit, the method comprising:
exchanging the credit of the third peer system for the first data chunk of the first peer system; and
using the credit received from the third peer system by the first peer system to exchange for the second data chunk of the second peer system.

11. The data exchange method of claim 10 further including using the credit received from the first peer system by the second peer system to exchange with the third peer system for a future data chunk of the third peer system.

12. The data exchange method of claim 11 wherein the credit includes an expiry limit, and the method further includes using the credit received by the second peer system in exchange for the future data chunk of the third peer system prior to the expiry limit.

13. The data exchange method of claim 11 further comprising verifying with the third peer system that the credit received from the second peer system in exchange for the future data chunk was previously issued by the third peer system.

14. The data exchange method of claim 1I1 further comprising encrypting the credit with the second peer system by using a private encryption key of the second peer system and a public encryption key of the third peer system, and decrypting the encrypted credit with the third peer system by using a public encryption key of the second peer system and a private encryption key of the third peer system.

15. The data exchange method of claim 10, wherein the credit includes a transaction record, and the method further comprises the first peer system verifying the transaction record prior to exchanging the first data chunk with the third peer system.

16. The data exchange method of claim 15, wherein the first peer system verifies the transaction record through a credit database.

17. The data exchange method of claim 10 further comprising encrypting the credit with the third peer system by using a public encryption key of the first peer system and a private encryption key of the third peer system, and decrypting the encrypted credit with the first peer system by using a private encryption key of the first peer system and a public encryption key of the third peer system.

18. The data exchange method of claim 10, wherein the credit includes a transaction record, and the method further comprises the second peer system verifying the transaction record prior to exchanging the second data chunk with the first peer system.

19. The data exchange method of claim 18, wherein the second peer system verifies the transaction record through a credit database.

20. The data exchange method of claim 18, wherein the second peer system verifies the transaction record through the third peer system.

21. The data exchange method of claim 10 further comprising encrypting the credit with the first peer system by using a public encryption key of the second peer system and a private encryption key of the first peer system, and decrypting the encrypted credit with the second peer system by using a private encryption key of the second peer system and a public encryption key of the first peer system.

22. The data exchange method of claim 10 wherein the credit includes an expiry limit, and the method further includes using the credit received by the first peer system in exchange for the second data chunk of the second peer system prior to the expiry limit.

23. The data exchange method of claim 10 wherein the third peer system issues the credit.

24. The data exchange method of claim 10 wherein the third peer system receives the credit from a fourth peer system.
